(19) United States
(12) Patent Application Publication
(10) Pub. No.: US 2013/0336491 A1
(43) Pub. Date: Dec. 19, 2013

(54) GROUPING SYSTEM

(71) Applicant: NEC BIGLOBE, LTD., Tokyo (JP)

(72) Inventors: Masaki HARA, Tokyo (JP); Naoto KIUCHI, Tokyo (JP); Noriyoshi ICHINOSE, Tokyo (JP)

(73) Assignee: NEC BIGLOBE, LTD., Tokyo (JP)

(21) Appl. No.: 13/833,599

(22) Filed: Mar. 15, 2013

(30) Foreign Application Priority Data
Jun. 19, 2012 (JP) 2012-137671

(51) Int. Cl. H04R 29/00

(52) U.S. Cl. CPC H04R 29/00
USPC 381/56

(57) ABSTRACT

Waveform generating section 100 generates a waveform, and waveform collecting sections 200-1 to 200-3 collect the waveform generated by waveform generating section 100. Waveform comparing section 300 compares waveforms collected by waveform collecting sections 200-1 to 200-3 with each other. Group generating section 400 groups waveform collecting sections 200-1 to 200-3, which collected identical waveforms, into one group as a result of comparison.

This application is based upon and claims the benefit of priority from Japanese Patent Application No. 2012-137671 filed on Jun. 19, 2012, the content of which is incorporated by reference.

### BACKGROUND OF THE INVENTION

1. Field of the Invention

The present invention relates to a grouping system that groups information processors, a grouping device, an information processor, a waveform generator, a waveform controller, and a method and a program for grouping.

2. Description of the Related Art

A technique that groups communication devices including a communication function for a specified purpose has been considered (see, for example, JP2001-36638A).

In the technique disclosed in JP2001-36638A, grouping is performed by using timing and the frequency of button pressing performed on a device and the environment surrounding the device as grouping conditions.

### SUMMARY OF THE INVENTION

However, in the technique as disclosed in JP2001-36638A, operation by a user is necessary and therefore the grouping takes time and effort. Moreover, when the environment surrounding the device is not in the level detectable by the device (such as the surrounding sound being low), the grouping cannot be performed.

An object of the present invention is to provide a grouping system, a grouping device, an information processor, a waveform generator, a waveform controller, and a method and a program for grouping which solve the above-stated problems.

A grouping system of the present invention includes:

a waveform generating section that generates a waveform;

waveform collecting sections that collect the waveform generated by said waveform generating section;

a waveform comparing section that compares waveforms collected by said waveform collecting sections with each other; and

a group generating section that groups waveform collecting sections that collected identical waveforms into one group as a result of comparison by said waveform comparing section.

A grouping device of the present invention includes:

a waveform control section that controls generation of a waveform in a waveform generating section that generates the waveform;

a waveform comparing section that compares waveforms indicated by a plurality of pieces of waveform information respectively transmitted from information processors with each other; and

a group generating section that groups information processors that transmitted waveform information indicating identical waveforms into one group as a result of comparison by said waveform comparing section.

An information processor of the present invention includes:

a waveform generating section that generates a waveform;

a waveform collecting section that collects the waveform generated by said waveform generating section; and

a communication section that transmits waveform information indicating the waveform collected by said waveform collecting section to a grouping device or other information processors.

A waveform generator of the present invention includes:

a storage section that stores waveform data respectively corresponding to a plurality of service types;

a control section that reads out waveform information corresponding to the service from said storage section; and

a waveform generating section that generates a waveform indicated by the waveform information read out by said control section.

A waveform controller of the present invention includes:

a waveform control section that controls timing of generating a waveform in a waveform generating section that generates the waveform, or controls a type of the waveform to be generated.

A grouping method of the present invention includes:

waveform generating processing of generating a waveform;

collecting processing of devices respectively collecting the generated waveform;

comparing processing of comparing waveforms respectively collected by the devices with each other; and

grouping processing of grouping the devices that collected identical waveforms into one group as a result of the comparison.

A program of the present invention

is a program for making a computer execute:

a procedure of generating a waveform,

a procedure of collecting the generated waveform, and

a procedure of transmitting waveform information indicating the collected waveform to a grouping device.

Another aspect of the present invention is a program for making a computer execute:

a procedure of storing a plurality of pieces of waveform data respectively corresponding to service types in a storage section provided in the computer,

a procedure of reading out waveform information corresponding to the service from the storage section; and

a procedure of generating a waveform indicated by the read waveform information.

Another aspect of the present invention is a program for making a computer execute:

a procedure of controlling timing of generating a waveform or a type of the waveform to be generated. As explained in the foregoing, it becomes possible to facilitate grouping in the present invention.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a view showing a first exemplary embodiment of a grouping system of the present invention;

FIG. 2 is a view showing a first example of an actual system with the first exemplary embodiment shown in FIG. 1 applied thereto;

FIG. 3 is a view showing a second example of the actual system with the first exemplary embodiment shown in FIG. 1 applied thereto;

FIG. 4 is a view showing a third example of the actual system with the first exemplary embodiment shown in FIG. 1 applied thereto;

FIG. 5 is a view showing a fourth example of the actual system with the first exemplary embodiment shown in FIG. 1 applied thereto;

FIG. 6 is a sequence diagram for explaining a grouping method in the exemplary embodiment shown in FIG. 1;

FIG. 7 is a view showing a second exemplary embodiment of the grouping system of the present invention;

FIG. 8 is a view showing a third exemplary embodiment of the grouping system of the present invention;

FIG. 9 is a view showing a fourth exemplary embodiment of the grouping system of the present invention; and

FIG. 10 is a view showing an example of an actual system with the fourth exemplary embodiment shown in FIG. 9 applied thereto.

### DETAILED DESCRIPTION OF THE PREFERRED EMBODIMENTS

The exemplary embodiments of the present invention are described hereinbelow with reference to the drawings.

### First Exemplary Embodiment

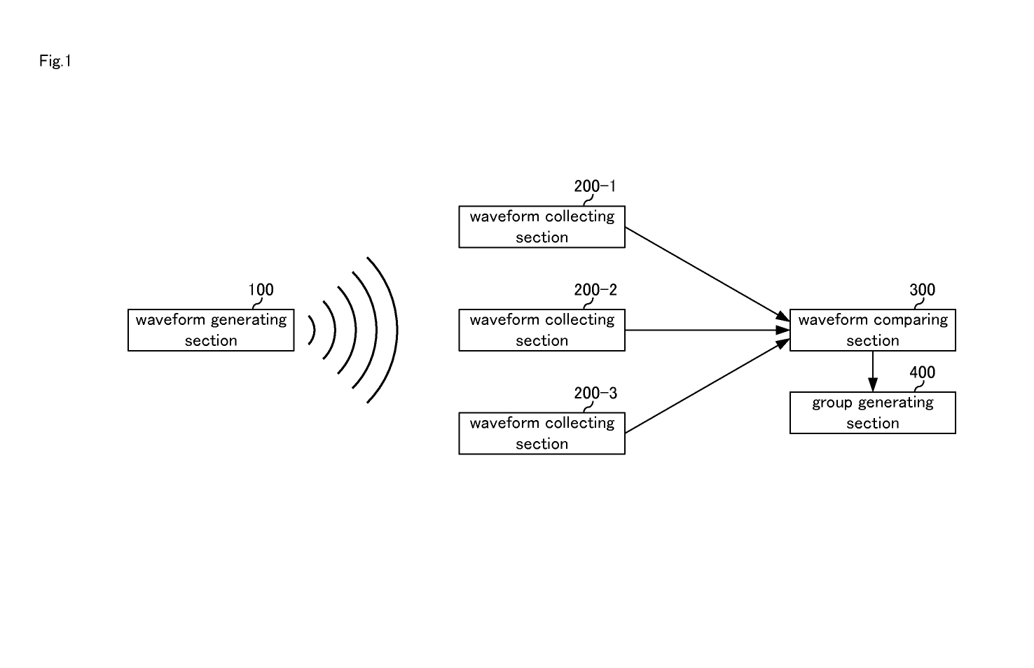

FIG. 1 shows a first exemplary embodiment of a grouping system including waveform generating section 100, waveform collecting sections 200-1 to 200-3, waveform comparing section 300, and group generating section 400. Although the example shown in FIG. 1 includes three waveform collecting sections, the number of the waveform collecting sections may be any number without being limited to three.

Waveform generating section 100 generates a specified waveform and outputs it by using a speaker, a vibrator and the like. The waveform is not limited to those that can be sensed by a human being such as acoustic waves and oscillatory waves but may be a waveform that cannot be sensed by a human being. For example, the waveform may be a supersonic wave which in an inaudible band of 17000 Hz or more and 20 Hz or less and whose waveform or oscillation cannot be sensed, as long as it is detectable by waveform collecting sections 200-1 to 200-3. For example, when the waveform is sound, it may be extracted from received television and radio broadcasting.

Waveform collecting sections 200-1 to 200-3 detect and collect a waveform outputted by waveform generating section 100 by using microphones, acceleration sensors and the like. Waveform collecting sections 200-1 to 200-3 also output waveform information indicating the collected waveform to waveform comparing section 300. Waveform collecting sections 200-1 to 200-3 may output waveform data representing the collected waveform itself as waveform information to waveform comparing section 300. Waveform collecting sections 200-1 to 200-3 may output a feature value converted from the collected waveform. One example of a method for converting a waveform into a feature value is shown below.

First, a frequency band is selected as an analysis target by such ways as shown below:
All frequency values are merged and analyzed.
A frequency value in every frequency band is analyzed.
Some frequency bands (200 Hz to 220 Hz, 420 Hz to 440 Hz, etc.) are set as an analysis target and frequency values therein are analyzed. Herein, setting of an arbitrary bandwidth is also performed.

In a target frequency band, a feature value is determined in such ways as shown below:
A maximum value in each section is determined as a feature value.
An average value in each section is determined as a feature value.
Top n (n being an integer) frequencies in each section are determined as a feature value.

When waveform collecting sections 200-1 to 200-3 output waveform information indicating the collected waveform to waveform comparing section 300, waveform collecting sections 200-1 to 200-3 also output waveform collecting section identification information that can identify respective waveform collecting sections 200-1 to 200-3 to waveform comparing section 300 together with the waveform information. When waveform collecting sections 200-1 to 200-3 output waveform information indicating the collected waveform to waveform comparing section 300, waveform collecting sections 200-1 to 200-3 may also output timing information indicating timing, such as time at which the waveform was collected, to waveform comparing section 300 together with the waveform information.

Herein, as for the timing of waveform collecting sections 200-1 to 200-3 outputting waveform information, waveform collecting sections 200-1 to 200-3 may collectively output the information after they complete detection of the waveform (after sound is stopped, after elapse of a specified time (e.g.: after elapse of 1 minute) and the like). Moreover, the timing for waveform collecting sections 200-1 to 200-3 to output waveform information may be after waveform collecting sections 200-1 to 200-3 start detection of the waveform and while waveform collecting sections 200-1 to 200-3 store waveform information indicating the waveform. The timing of stopping output of waveform information may be after elapse of specified time (e.g.: after elapse of 1 minute) or after waveform comparing section 300 reports completion of comparison.

Moreover, as for the timing of waveform collecting sections 200-1 to 200-3 collecting the waveform, waveform collecting sections 200-1 to 200-3 may start to collect a waveform or start to output waveform information when a specified waveform different from the waveform generated by waveform generating section 100 is generated and is identified as a start waveform in waveform collecting sections 200-1 to 200-3.

Waveform comparing section 300 compares the waveforms respectively indicated by a plurality of pieces of the waveform information outputted from each of waveform collecting sections 200-1 to 200-3 with each other. When waveform data on the waveform itself has been outputted as waveform information from each of waveform collecting sections 200-1 to 200-3, waveform comparing section 300 compares the waveform data with each other. When a feature value of the waveform has been outputted as waveform information from each of waveform collecting sections 200-1 to 200-3, waveform comparing section 300 compares the feature values with each other. Waveform comparing section 300 also reports a compared result to group generating section 400. More specifically, waveform comparing section 300 reports a plurality of pieces of waveform collecting section identification information, which were outputted together with waveform information indicating waveforms (waveform data, feature values) matched with each other, to group generating section 400.

In the case where timing information has been outputted from waveform collecting sections 200-1 to 200-3, waveform comparing section 300 may perform waveform comparison based on the timing indicated by the timing information. In short, waveform comparing section 300 compares the waveforms whose timing overlaps each other.

Group generating section 400 gathers a plurality of pieces of the waveform collecting section identification information of the waveform collecting sections which collected the waveforms reported by waveform comparing section 300 to be matched with each other, and generates a group by grouping them into one group. Group generating section 400 also assigns group identification information for identifying the group to the generated group. The group identification information may be generated by using matched waveforms or by using random numbers and the like. Group generating section 400 may also register association between the group identification information on the generated group and a plurality of pieces waveform collecting section identification information on the waveform collecting sections included in the group as group information onto a database (unshown) included in group generating section 400.

The registered group information is used when a service is provided. A concrete example thereof is mentioned later.

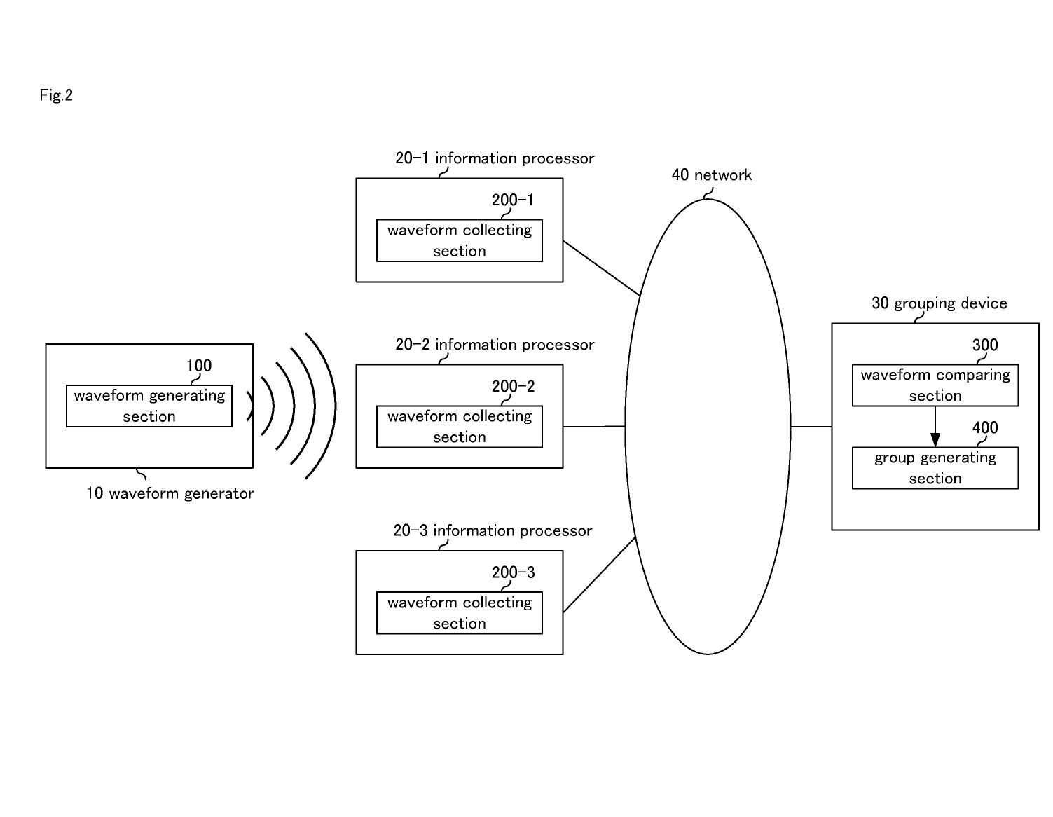

As shown in FIG. 2, in the first example, waveform generating section 100 shown in FIG. 1 is provided in waveform generator 10. Waveform collecting sections 200-1 to 200-3 shown in FIG. 1 are also respectively provided in information processors 20-1 to 20-3. Waveform comparing section 300 and group generating section 400 shown in FIG. 1 are also provided in grouping device 30.

Waveform generator 10 includes waveform generating section 100 provided at a position where a waveform generated by waveform generating section 100 can be discharged (outputted) to the outside. Waveform generator 10 may further include a storage section that stores waveform data corresponding to respective a plurality of service types and a control section that reads out waveform data corresponding to the service from the storage section.

Information processors 20-1 to 20-3 are devices connected to network 40 which is a communication network so as to have a communication function. Although information processors 20-1 to 20-3 are regarded and described as communication terminals with a communication function, they are not restricted thereby. For example, information processors 20-1 to 20-3 may be computers such as personal computers, tablet terminals, mobile phones, smart phones, game consoles and handy terminals, as well as modules such as semiconductors and substrates. Information processors 20-1 to 20-3 also respectively include microphones and the like as waveform collecting sections 200-1 to 200-3. Information processors 20-1 to 20-3 also transmit waveform information (waveform data, feature values) indicating the waveforms collected by waveform collecting sections 200-1 to 200-3 to grouping device 30 via network 40 by using a communication section provided in each of information processors 20-1 to 20-3. Waveform collecting section identification information transmitted together with the waveform information transmitted at this time may be, for example, device identification information preassigned to information processors 20-1 to 20-3 so as to be identified (such as IP (Internet Protocol) addresses, MAC (Media Access Control) addresses, telephone numbers, e-mail addresses, UIDs (User IDs)), and user identification information for identifying users who use information processors 20-1 to 20-3.

Grouping device 30 is a device which is connected to network 40 so as to be accessible from the information processors connected to network 40. Although grouping device 30 is regarded and described as a server, it is not restricted thereby. For example, grouping device 30 may be computers such as personal computers, tablet terminals, mobile phones, smart phones, game consoles and handy terminals, as well as modules such as semiconductors and substrates.

Upon reception of waveform information transmitted from information processors 20-1 to 20-3, grouping device 30 may store the received waveform information as uncompared waveform information and extract, from the uncompared waveform information, waveform information whose timing information and waveform are matched with each other, and a plurality of pieces of waveform collecting section identification information outputted together with the extracted waveform information may be reported by waveform comparing section 300 to group generating section 400. When grouping device 30 receives or transmits waveform information in advance, grouping device 30 may store the received or transmitted device identification information in association with waveform information, and may extract waveform information for comparison by using the associated waveform information as a reference.

Grouping device 30 may also feed back to information processors 20-1 to 20-3 a comparison state (such as a waveform level (amplitude), a state of completion of comparing processing) in waveform comparing section 300 or the waveform itself received in waveform comparing section 300, and information processors 20-1 to 20-3 may display the comparison state on an indicator (unshown). This makes it possible to expect an effect in which the user changes a position and a posture of information processors 20-1 to 20-3 in order to obtain a sufficiently comparable state.

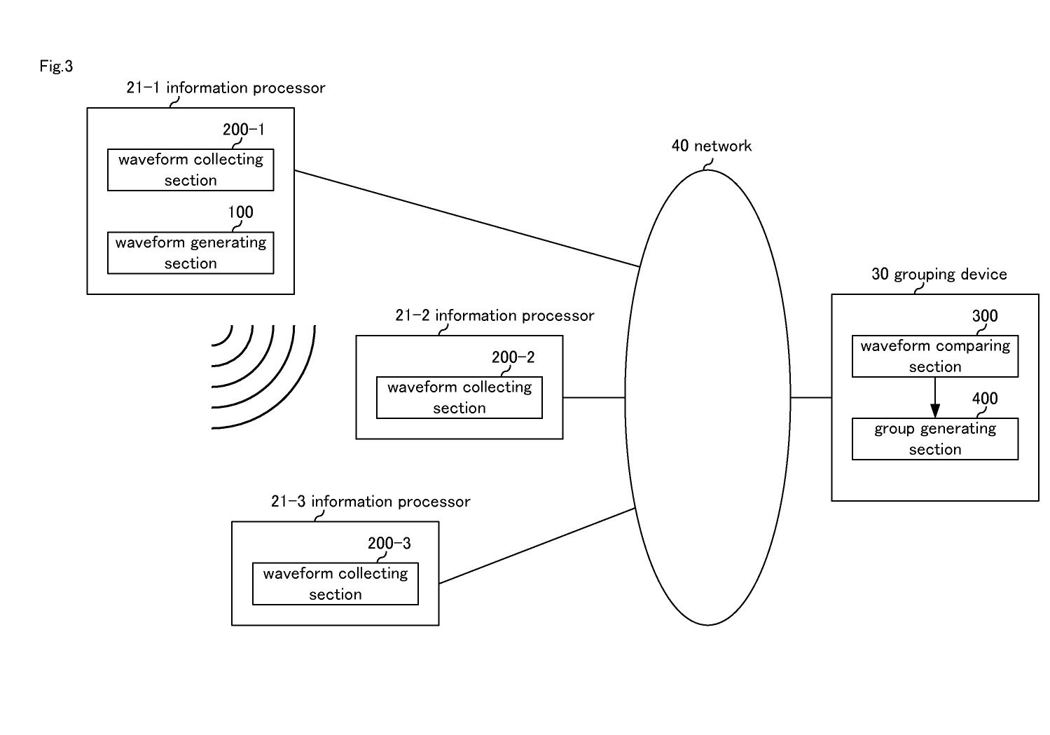

As shown in FIG. 3, in a second example, waveform generating section 100 and waveform collecting section 200-1 shown in FIG. 1 are provided in information processor 21-1. Waveform collecting sections 200-2 to 200-3 shown in FIG. 1 are also respectively provided in information processors 21-2 to 21-3. Waveform comparing section 300 and group generating section 400 shown in FIG. 1 are also provided in grouping device 30.

While the example shown in FIG. 2 shows a case where waveform generating section 100 is provided in an independent device, an example shown in FIG. 3 shows a case where waveform generating section 100 is provided in any one of information processors 21-1 to 21-3 (information processor 21-1 in FIG. 3).

Information processor 21-1 includes waveform generating section 100 provided at a position where a waveform generated by the waveform generating section 100 can be discharged (outputted) to the outside. Other functions of information processor 21-1 are similar to the functions provided for information processor 20-1 shown in FIG. 2.

Functions of information processors 21-2 to 21-3 are similar to the functions provided for information processors 20-2 to 20-3 shown in FIG. 2.

Grouping device 30 transmits and receives information about a service provided to a group generated by group generating section 400 with device identification information belonging to the group as a destination.

In the exemplary embodiment shown in FIG. 3, information processor 21-1 displays a button (which may be allocated to an existing button provided in information processor 21-1) on an indicator (unshown) of information processor 21-1 for selecting whether to generate a reference waveform. Upon reception of operation such as pressing or touching of the button for generating the reference waveform from a user, waveform generating section 100 reads out waveform data (such as sound and vibration) stored in information processor 21-1 and outputs it by using a speaker or the like. Or alternatively, information processor 21-1 uses waveform collecting section 200-1 to input a current waveform, and analyzes and determines whether or not a waveform suitable for comparison is inputted (whether an output is equal to or more than a specified level, whether sound is different from generally inputted one). If it is determined that the waveform suitable for comparison is not inputted, then waveform generating section 100 reads out waveform data (such as sound and vibration) stored in information processor 21-1 and outputs it by using a speaker or the like. It is to be noted that waveform data stored in information processor 21-1 may be waveforms themselves, and may be information (key & pitch or a program for generating waveform data from numeric values such as time and random numbers) for generating a waveform on demand In this case, information processor 21-1 may display titles (waveform information identification information) of a plurality of pieces of stored waveform data and make a user select one of waveform data from among a plurality of waveform data. Information processor 21-1 may analyze and determine whether or not the waveform suitable for comparison is inputted, and as a result, information processor 21-1 may select out of a plurality of pieces of the stored waveform data a waveform suitable for comparison whose frequency band or range is different from those of the inputted waveform, in accordance with frequency bands, ranges, and the like. Information processor 21-1 may also require waveform information identification information (or waveform data itself) that identifies waveform information to grouping device 30 including waveform comparing section 300, and may select waveform data specified by the waveform information identification information transmitted from grouping device 30 in response to the request.

Moreover, if it is detected in information processor 21-1 that a button to perform comparison without generation of a reference waveform was inputted, or if it is determined that a waveform suitable for comparison was inputted, comparison may be performed with surrounding environmental sound.

Hereinbelow, two methods for adding an information processor to the exemplary embodiment shown in FIG. 3 are described. However, these methods are only illustrative examples and other methods may be used instead.

### FIRST EXAMPLE OF METHOD

Once an instruction for adding an information processor is inputted into information processor 21-1 by operation of a user, information processor 21-1 generates a waveform identical to the previous waveform from waveform generating section 100 of information processor 21-1, and transmits to grouping device 30 the instruction for adding an information processor and device identification information or group identification information of information processor 21-1.

Grouping device 30 compares a waveform indicated by waveform information that was stored in the past and specified by the device identification information or the group identification information of information processor 21-1 with a waveform indicated by the waveform information transmitted from an added information processor. If the waveforms are matched with each other as a result of comparison, grouping device 30 allocates device identification information on an added information processor to the group identified by the device identification information or the group identification information of information processor 21-1. The foregoing is the description of the first example of the method for adding an information processor.

### SECOND EXAMPLE OF METHOD

Once an instruction for adding an information processor is inputted into information processor 21-1 by operation of a user, information processor 21-1 generates a waveform from waveform generating section 100 of information processor 21-1, and transmits to grouping device 30 an instruction for adding an information processor and device identification information or group identification information of information processor 21-1. At the same time, waveform collecting section 200-1 of information processor 21-1 also detects a waveform, and information processor 21-1 transmits waveform information indicating the collected waveform to grouping device 30.

Grouping device 30 compares the waveform indicated by the waveform information transmitted from information processor 21-1 with a waveform indicated by waveform information transmitted from an added information processor. If the waveforms are matched with each other as a result of comparison, grouping device 30 allocates device identification information on the added information processor to the group of the device identification information or to the group identified by the group identification information of information processor 21-1. The foregoing is a description of the second example of the method for adding an information processor.

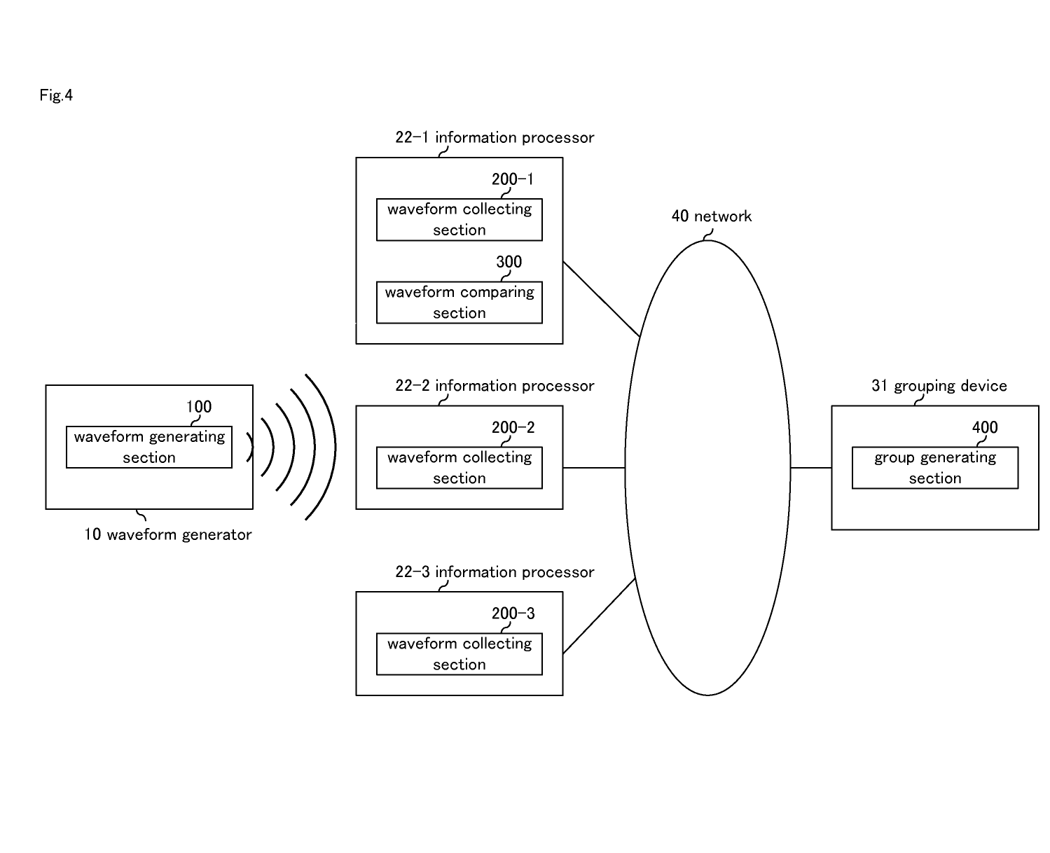

As shown in FIG. 4, in a third example, waveform generating section 100 shown in FIG. 1 is provided in waveform generator 10. Waveform collecting sections 200-1 to 200-3 shown in FIG. 1 are also respectively provided in information processors 22-1 to 22-3. Waveform comparing section 300 shown in FIG. 1 is also provided in information processor 22-1. Group generating section 400 shown in FIG. 1 is also provided in grouping device 31.

While the example shown in FIG. 2 shows a case where waveform comparing section 300 is provided in grouping device 30, an example shown in FIG. 4 shows a case where waveform comparing section 300 is provided in any one of information processors 22-1 to 22-3 (information processor 22-1 in FIG. 4). Accordingly, it is not necessary to provide waveform comparing section 300 in grouping device 31.

Information processors 22-2 to 22-3 also transmit waveform information (waveform data, feature values) indicating the waveforms collected by waveform collecting sections 200-2 to 200-3 to information processor 22-1 via network 40 by using a communication section provided in each of information processors 22-2 to 22-3.

Information processor 22-1 outputs waveform information indicating the waveform collected by waveform collecting section 200-1 to waveform comparing section 300. Waveform comparing section 300 in information processor 22-1 compares the waveform indicated by the waveform information outputted from waveform collecting section 200-1 and waveforms indicated by waveform information transmitted from information processor 22-2 to 22-3 with each other. Waveform comparing section 300 in information processor 22-1 also transmits a compared result to grouping device 31 via network 40. More specifically, waveform comparing section 300 transmits to grouping device 31 a plurality of pieces of waveform collecting section identification information (device identification information) outputted or transmitted together with waveform information (waveform data, feature values) indicating waveforms matched with each other. It is necessary to make information processor 22-2 to 22-3 recognize that information processor 22-1 includes waveform comparing section 300. For example, information processor 22-1 reports inclusion of waveform comparing section 300 (declaration of being “parent device”) and destination information (such as an IP address of information processor 22-1), which is necessary for information transmission to information processor 22-1, to information processors 22-2 to 22-3 connected to a pertinent service via broadcast communication or grouping device 31. The reporting is performed based on specified operation of information processor 22-1 by a user.

Once grouping device 31 receives the result of comparison from information processor 22-1, group generating section 400 in grouping device 31 generates a group by grouping a plurality of pieces of waveform collecting section identification information together into one group. The foregoing is a description of the grouping method.

It is to be noted that waveform comparing section 300 may be provided in grouping device 31. In this case, users of information processor 22-1 to 22-3 may be able to operate information processors 22-1 to 22-3 to select which waveform comparing section to use.

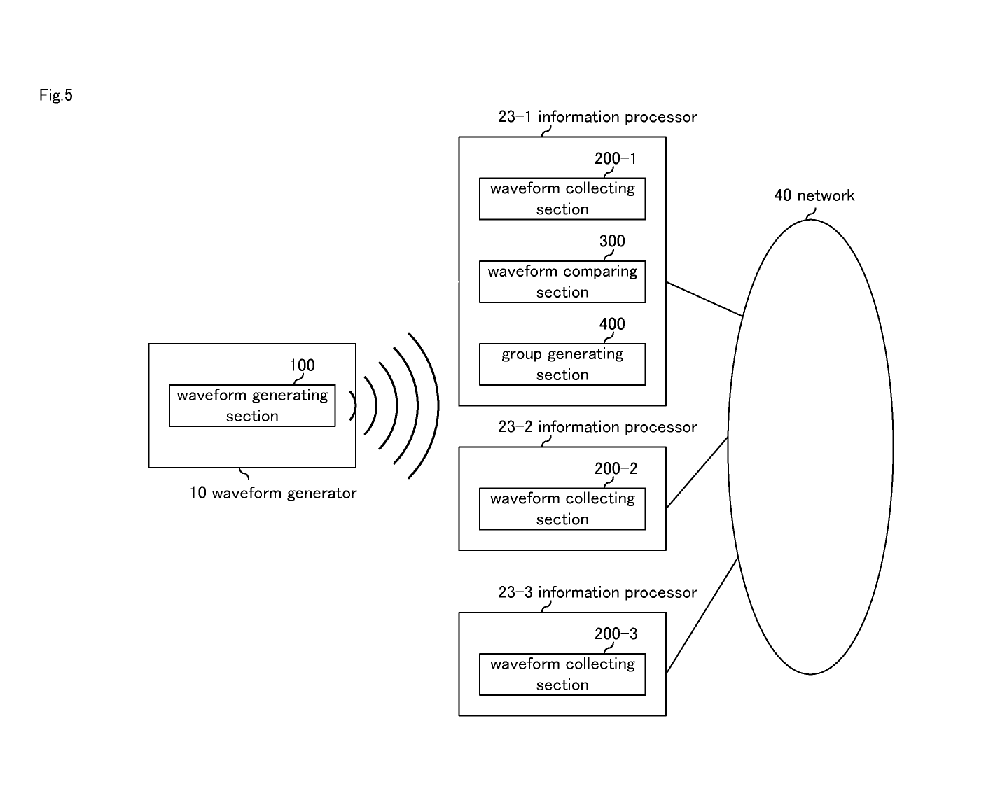

As shown in FIG. 5, in a fourth example, waveform generating section 100 shown in FIG. 1 is provided in waveform generator 10. Waveform collecting sections 200-1 to 200-3 shown in FIG. 1 are also respectively provided in information processors 23-1 to 23-3. Waveform comparing section 300 and group generating section 400 shown in FIG. 1 are also provided in information processor 23-1.

While the example shown in FIG. 2 shows the case where waveform comparing section 300 and group generating section 400 are provided in grouping device 30, an example shown in FIG. 5 shows a case where waveform comparing section 300 and group generating section 400 are provided in any one of information processors 23-1 to 23-3 (information processor 23-1 in FIG. 5).

Information processors 23-2 to 23-3 transmit waveform information (waveform data, feature values) indicating the waveforms collected by waveform collecting sections 200-2 to 200-3 to information processor 23-1 via network 40 by using a communication section provided in each of information processors 23-2 to 23-3.

Information processor 23-1 outputs waveform information indicating the waveform collected by waveform collecting section 200-1 to waveform comparing section 300. Waveform comparing section 300 in information processor 23-1 compares the waveform indicated by the waveform information outputted from waveform collecting section 200-1 and the waveforms indicated by waveform information transmitted from information processors 23-2 to 23-3 with each other. Waveform comparing section 300 in information processor 23-1 also outputs a compared result to group generating section 400 in information processor 23-1. More specifically, waveform comparing section 300 outputs to group generating section 400 a plurality of pieces of waveform collecting section identification information (device identification information) outputted or transmitted together with waveform information (waveform data, feature values) indicating waveforms matched with each other. Based on the result of comparison outputted from waveform comparing section 300, group generating section 400 in information processor 23-1 generates a group by grouping a plurality of pieces of waveform collecting section identification information into one group. The foregoing is a description of the grouping method.

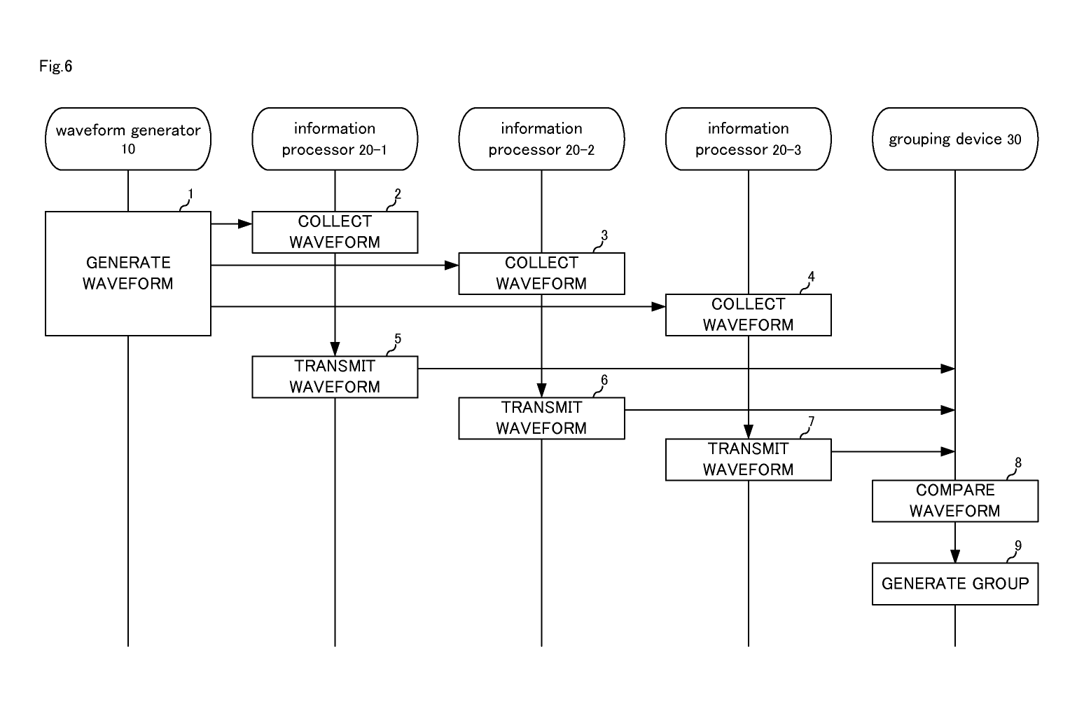

Hereinbelow, a grouping method in this embodiment is described with reference to FIG. 6. Herein, a description is given by taking as an example a case where the first exemplary embodiment shown in FIG. 1 is applied to the system shown in FIG. 2.

First, waveform generating section 100 of waveform generator 10 generates a specified waveform in Step 1. At this time, waveform generator 10 may generate a waveform corresponding to a service provided to information processors 20-1 to 20-3.

Then, waveform collecting section 200-1 of information processor 20-1 detects and collects the waveform in Step 2. Waveform collecting section 200-2 of information processor 20-2 also detects and collects the waveform in Step 3. Waveform collecting section 200-3 of information processor 20-3 also detects and collects the waveform in Step 4.

Information processor 20-1 which collected the waveform transmits waveform information indicating the waveform from a communication section provided therein to grouping device 30 via network 40 in Step 5. At this time, information processor 20-1 also transmits device identification information (for example, “A0001”) on information processor 20-1 as mentioned above. Similarly, information processor 20-2 which collected the waveform transmits waveform information indicating the waveform from a communication section provided therein to grouping device 30 via network 40 in Step 6. At this time, information processor 20-2 also transmits device identification information (for example, “B0001”) on information processor 20-2 as mentioned above. Similarly, information processor 20-3 which collected the waveform transmits waveform information indicating the waveform from a communication section provided therein to grouping device 30 via network 40 in Step 7. At this time, information processor 20-3 also transmits terminal identification information (for example, “C0001”) on information processor 20-3 as mentioned above.

Once grouping device 30 receives the waveform information transmitted from information processors 20-1 to 20-3, grouping device 30 compares with each other the waveforms indicated by three pieces of waveform information received in waveform comparing section 300 in Step 8. Waveform comparing section 300 reports a result of comparison to group generating section 400, and group generating section 400 generates a group based on the result of comparison reported from waveform comparing section 300 in Step 9.

Although it was explained that waveform comparing processing of Step 8 is to be performed after all the waveform information are received from information processors 20-1 to 20-3 in this description, an exemplary embodiment is also possible in which waveform comparing of Step 8 is started not upon reception of all waveform information but upon reception of part of the waveform information so as to execute the comparison processing ahead of schedule. For example, upon reception of the waveform information from information processor 20-1 and 20-2, waveform comparing processing of Step 8 may be started.

Now, group formation is described by giving a concrete example.

Waveform comparing section 300 compares a waveform (waveform A) indicated by waveform information transmitted from information processor 20-1 with a waveform (waveform B) indicated by waveform information transmitted from information processor 20-2. Waveform comparing section 300 also compares waveform A with a waveform (waveform C) indicated by waveform information transmitted from information processor 20-3. Waveform comparing section 300 also compares waveform B with waveform C. When waveform A and waveform B are matched, waveform A and waveform C are not matched, and waveform B and waveform C are not matched as a result of comparison, waveform comparing section 300 reports to group generating section 400 that waveform A of device identification information “A0001” and waveform B of device identification information “B0001” were matched as a result of comparison. Group generating section 400 then registers the device identification information “A0001” and “B0001” as one group. When group generating section 400 registers a generated group, the group is registered in association with group identification information (for example, “G0001”).

Grouping device 30 may also transmit the group identification information to information processors whose device identification information belongs to the group.

The group registered in this way may be used as a group which can share, for example, a message interchange service and services such as a bulletin board service and SNS (Social Networking Service) among information processors whose device identification information share the same group identification information. Grouping device 30 also generates connection destination identifiers (such as URLs (Uniform Resource Locators)) for using these services and provides them to the information processors belonging to the group.

### SECOND EXEMPLARY EMBODIMENT

Although the case of one waveform generating section 100 is shown in the first exemplary embodiment, waveform generating sections may also be provided.

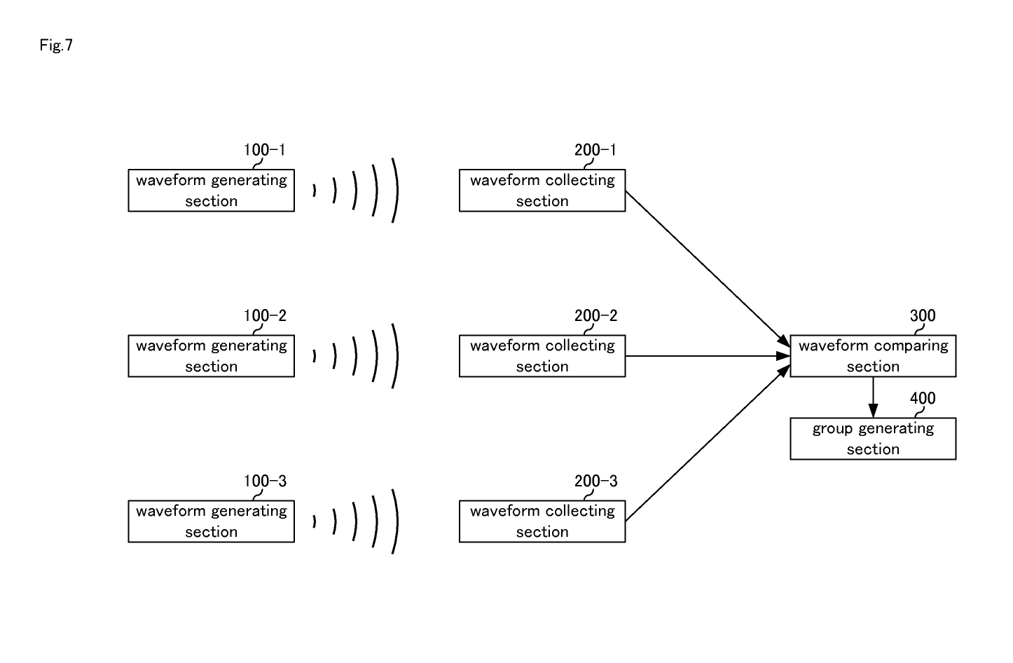

FIG. 7 shows a second exemplary embodiment of the grouping system including waveform generating sections 100-1 to 100-3, waveform collecting sections 200-1 to 200-3, waveform comparing section 300, and group generating section 400. Although the example shown in FIG. 7 includes three waveform generating sections and waveform collecting sections, the number of the waveform generating sections and the waveform collecting sections may be any number without being limited to three.

Waveform generating sections 100-1 to 100-3 include the same functions as waveform generating section 100 shown in FIG. 1.

Other component members shown in FIG. 7 include the same functions as those shown in FIG. 1.

These component members are placed in the waveform generator, the information processor and the grouping device as in the first exemplary embodiment.

### THIRD EXEMPLARY EMBODIMENT

Waveforms generated by the waveform generating section may be recognized in advance in the waveform comparing section.

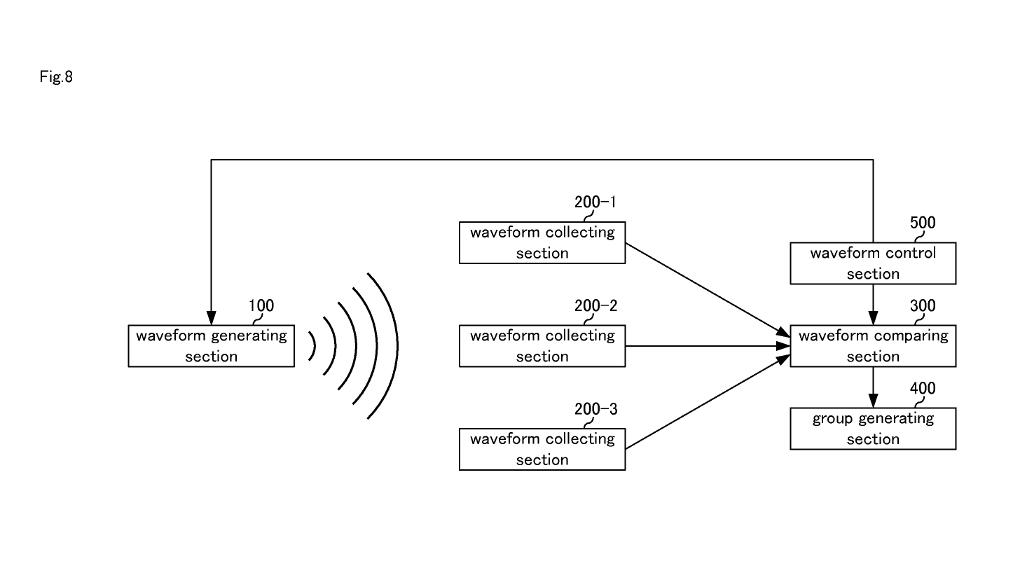

FIG. 8 shows a third exemplary embodiment of the grouping system including waveform generating section 100, waveform collecting sections 200-1 to 200-3, waveform comparing section 300, group generating section 400, and waveform control section 500. Although the example shown in FIG. 8 includes three waveform collecting sections, the number of the waveform collecting sections may be any number without being limited to three.

Waveform control section 500 controls waveform generating section 100 and waveform comparing section 300. More specifically, waveform control section 500 controls waveform generation in waveform generating section 100 (such as timing of generating a waveform), and reports a control detail as waveform information to waveform comparing section 300. Waveform control section 500 also changes waveforms to be generated by waveform generating section 100 depending on a result of comparison in waveform comparing section 300.

When waveform generating section 100 generates sound as a waveform, waveform control section 500 controls waveform generating section 100 as shown below:
To generate preset sound.
To generate sound in preset order, or to generate sound at random.
To generate sound set for every service to be provided.
To generate different sound when waveforms matched with each other are not present in waveform comparing section 300.
To change a waveform to be generated when correct matching (comparison) cannot be performed.
To generate sound corresponding to a time zone (morning, noon, night).
To generate sound corresponding to a location (indoor, outdoor).
To generate sound corresponding to a history (sound selected in the past).

Waveform control section 500 may order waveform generating section 100 to change waveform output so that waveforms with a high precision and a low matching probability (such as the sound with a lot of minute changes and a short hearing range) are generated first and if there are no waveforms matched with each other, the waveforms are changed to those with low precision and high matching probability (such as monotonous and loud sound with a long hearing range).

Waveform control section 500 may also order waveform generating section 100 to execute finely-tuned comparison, that is, waveforms with low precision and a high matching probability are generated first, and after grouping is performed by rough comparison, waveforms with high precision and low matching probability are generated so as to promote differentiation from other groups.

Waveform comparing section 300 performs waveform comparison with use of a waveform indicated by waveform information reported from waveform control section 500. In short, waveform comparing section 300 makes a comparison between a reference waveform indicated by the waveform information (reference waveform information) reported from waveform control section 500 to be used as reference and the waveforms outputted from waveform collecting sections 200-1 to 200-3. Waveform comparing section 300 may also determine whether or not the respective waveforms outputted from waveform collecting sections 200-1 to 200-3 are matched with the reference waveform indicated by the waveform information reported from waveform control section 500.

Thus, waveform control section 500 controls the waveform generated from waveform generating section 100 and reports it to waveform comparing section 300. As a consequence, waveform generating section 100 and waveform comparing section 300 can recognize the waveform to be generated, which facilitates comparison in waveform comparing section 300.

It is to be noted that the device to which, from among the waveform generator, the information processor and the grouping device, waveform generating section 100, waveform comparing section 300, group generating section 400 and waveform control section 500 shown in FIG. 8 are mounted, is not specified. For example, waveform generating section 100 may be mounted on the waveform generator or the information processor, and waveform comparing section 300, group generating section 400 and waveform control section 500 may be mounted on the grouping device. Waveform control section 500 may also be mounted on the information processor.

A controller (waveform controller) independent from the waveform generator, the information processor and the grouping device may be provided, and waveform control section 500 may be mounted on this waveform controller. Waveform generating section 100 and waveform control section 500 may also be mounted on the waveform controller. Waveform generating section 100, waveform comparing section 300, and waveform control section 500 may also be mounted on the waveform controller.

### FOURTH EXEMPLARY EMBODIMENT

Waveform generating sections may be provided and controlled as in the second exemplary embodiment.

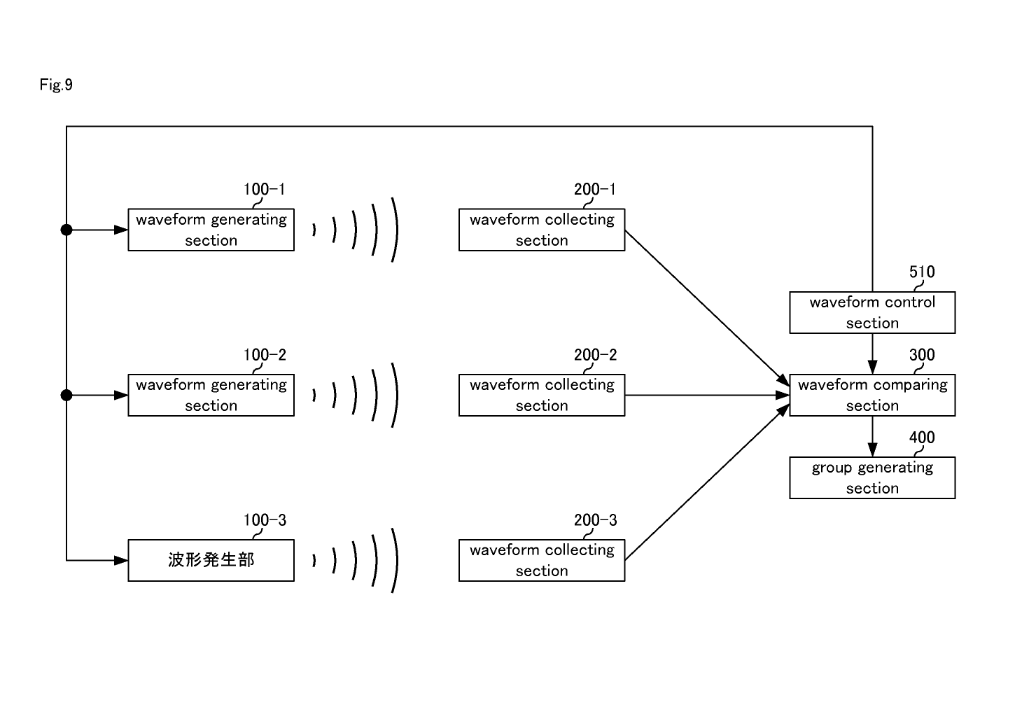

FIG. 9 shows a fourth exemplary embodiment of the grouping system including waveform generating sections 100-1 to 100-3, waveform collecting sections 200-1 to 200-3, waveform comparing section 300, group generating section 400, and waveform control section 500. Although the example shown in FIG. 9 includes three waveform generating sections and waveform collecting sections, the number of the waveform generating sections and the waveform collecting sections may be any number without being limited to three.

Waveform control section 510 includes the function of waveform control section 500 shown in FIG. 8 as well as a function of controlling the types and timing of waveforms to be generated by waveform generating sections 100-1 to 100-3. More specifically, waveform control section 510 controls so that respective waveform generation (output) timing in waveform generating sections 100-1 to 100-3 does not overlap each other. In another exemplary embodiment, waveform control section 510 controls so that waveform frequency bands of the respective waveforms in waveform generating sections 100-1 to 100-3 do not overlap each other. For example, waveform control section 510 controls so that waveform generating section 100-1 uses 100 Hz-200 Hz, waveform generating section 100-2 uses 300 Hz-400 Hz and waveform generating section 100-3 uses 500 Hz-600 Hz. Thus, controlling the timing and the waveform types makes it possible to prevent any failure in collecting correct waveform data in which failure would be caused by the waveforms, that are generated by waveform generating sections 100-1 to 100-3, cancelling each other out, i.e., interfering with each other.

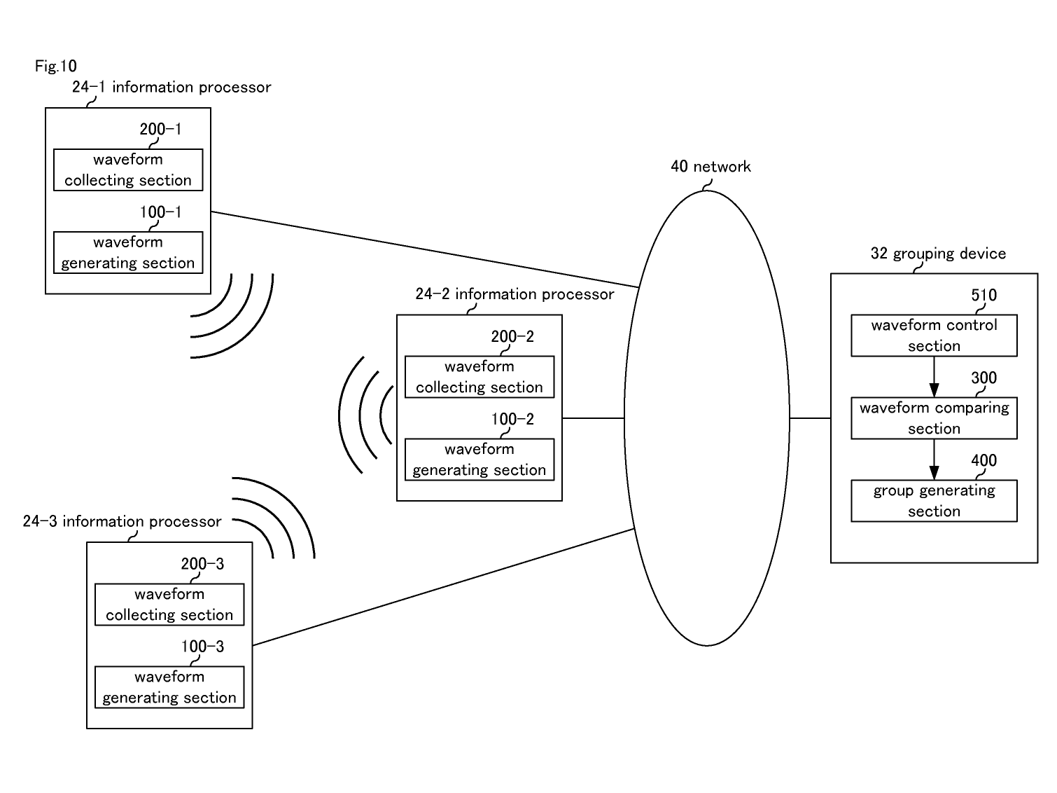

FIG. 10 shows an example of the actual system with the fourth exemplary embodiment shown in FIG. 9 applied thereto.

As shown in FIG. 10, waveform generating section 100-1 and waveform collecting section 200-1 shown in FIG. 9 are provided in information processor 24-1. Waveform generating section 100-2 and waveform collecting section 200-2 shown in FIG. 9 are also provided in information processor 24-2. Waveform generating section 100-3 and waveform collecting section 200-3 shown in FIG. 9 are also provided in information processor 24-3. Waveform comparing section 300, group generating section 400 and waveform control section 510 shown in FIG. 9 are also provided in grouping device 32. An example of operation in the exemplary embodiment shown in FIG. 10 is described below.

First, after information processors 24-1 to 24-3 start a specified application or synchronize time in response to operation by a user, they transmit a waveform generation permission request notice to grouping device 32. Once grouping device 32 receives the waveform generation permission request notice transmitted from information processors 24-1 to 24-3, waveform control section 510 changes waveform information identification information for identifying waveform information and timing information so that parameters such as frequency bands and pitches become unique. Grouping device 32 transmits these changed information to information processors 24-1 to 24-3 (waveform generating sections 100-1 to 100-3). For example, when there are 100 types of waveform information from information 1 to information 100, grouping device 32 transmits waveform information identification information formed of a combination of waveform information 1 and waveform information 10, and then in the subsequent transmission, grouping device 32 transmits waveform information identification information formed of a combination of waveform information 2 and waveform information 11. Grouping device 32 also transmits timing information for generating a waveform in subsequent 1 minute to information processor 24-1, transmits timing information for generating a waveform in 1 minute subsequent thereto to information processor 24-2, and transmits timing information of generating a waveform in 1 minute further subsequent thereto to information processor 24-3.

Upon reception of the waveform information identification information or the timing information transmitted from grouping device 32, information processors 24-1 to 24-3 read out waveforms with specified waveform information identification information allotted thereto from storage sections respectively provided in information processors 24-1 to 24-3 based on received timing information. Information processors 24-1 to 24-3 then output (generate) the read waveforms from waveform generating sections 100-1 to 100-3.

When information processors 24-1 to 24-3 transmit to grouping device 32 information on the number of processors expected to be connected, inputted based on operation of a user, and grouping device 32 receives the information on the number of processors expected to be connected, then waveform control section 510 may select or generate a waveform, which can be sufficiently collected by the number of processors indicated by the received information on the number of processors expected to be connected, and timing of the waveform. Waveform control section 510 may transmit to information processors 24-1 to 24-3 waveform information identification information and timing information corresponding to the generated waveform and timing.

As other methods for controlling waveform generation timing in waveform generating sections 100-1 to 100-3 so as to prevent the timing from being overlapping each other, the following two methods may further be considered.

In the first method, when information processors 24-1 to 24-3 confirms from waveform collecting sections 200-1 to 200-3 that waveforms have not been generated from other waveform generating sections 100-1 to 100-3, then waveform generating sections 100-1 to 100-3 in information processors 24-1 to 24-3, which made confirmation, output a waveform.

In the second method, if grouping device 32 has not received a waveform generation permission request notice within a fixed time in any information processor in the same area or in the same organization at the time when grouping device 32 receives a waveform generation permission request notice transmitted from each information processor 24-1 to 24-3, then grouping device 32 transmits to information processors 24-1 to 24-3 a notice of permission including waveform information identification information, which specifies a waveform type, and timing information which indicates timing of generating a waveform indicated by the waveform information identification information. However, if grouping device 32 has received a waveform generation permission request notice in an information processor in the same area or organization within a fixed time, then grouping device 32 transmits a notice of disapproval.

In the fourth exemplary embodiment, a description is given of the case where waveform control section 500 controls so that waveforms generated by waveform generating sections 100-1 to 100-3 do not overlap each other. However, it is also effective to control so that waveforms generated in the respective waveform generating sections overlap each other. Waveform control section 500 that controls so as to overlap the waveforms makes it possible to form a unique waveform which flows only in that environment and not in any other environment. In other words, if waveforms are generated in only one waveform generating section, similar waveforms may incidentally be observed in other environments. However, by overlapping the waveforms from waveform generating sections, it is expected that a waveform that can be observed in that place but not in other environments will be formed.

Thus, as described in the first exemplary embodiment to the fourth exemplary embodiment, by generating a reference waveform used as a reference and by grouping the information processors that detected identical waveforms, grouping can be easily performed even in a soundless room or in the case where only the sound in the streets can be inputted.

Processing performed by each component member provided in the above-described waveform generator, information processor and grouping device may be performed in logical circuits each manufactured depending on the purpose for which they are to be used. A computer program (hereinafter referred to as a program) that is processing details described as procedures may be recorded onto a recording medium readable in each of the waveform generator, information processor and grouping device. The program recorded on the recording medium may be loaded onto each of the waveform generator, the information processor and the grouping device for execution. The recording medium readable in each of the waveform generator, the information processor and the grouping device refers to a removable recording medium such as floppy (registered trademark) disks, magneto-optic disks, DVDs, and CDs, as well as to a memory device such as ROM and RAM and an HDD which is built into the waveform generator, the information processor and the grouping device. The program recorded on the recording medium is loaded onto a CPU (unshown) provided in the waveform generator, the information processor and the grouping device, and the same processing as described above is executed under control of the CPU. The CPU herein refers to a device operated as a computer which executes the program loaded from the recording medium that stores the program.

Although a part or all of the foregoing exemplary embodiments may also be described as shown in the following appended features, they are not restricted thereby.
(Feature 1) Grouping system, including:

a waveform generating section that generates a waveform;

waveform collecting sections that collect the waveform generated by said waveform generating section;

a waveform comparing section that compares waveforms collected by said waveform collecting sections with each other; and

a group generating section that groups waveform collecting sections that collect identical waveforms into one group as a result of comparison by said waveform comparing section.
(Feature 2) The grouping system according to feature 1, wherein

said waveform comparing section compares feature values of the waveforms with each other, and

said group generating section groups waveform collecting sections that collect waveforms identical in feature value into one group as a result of comparison by said waveform comparing section.
(Feature 3) The grouping system according to feature 1 or 2, including

a waveform control section that controls generation of the waveform in said waveform generating section, wherein

said waveform control section reports waveform information indicating the waveform generated by said waveform generating section to said waveform comparing section, and

said waveform comparing section performs the comparison by using the waveform indicated by the waveform information reported from said waveform control section.
(Feature 4) The grouping system according to any one of features 1 to 3, wherein

said waveform collecting section outputs to said waveform comparing section timing information indicating timing during which the waveform was collected together with the waveform information indicating the collected waveform, and

said waveform comparing section performs the comparison based on the timing indicated by the timing information.
(Feature 5) The grouping system according to any one of features 1 to 4, comprising:

a waveform generator including said waveform generating section;

information processors respectively including said waveform collecting sections; and

a grouping device including said waveform comparing section and said group generating section.
(Feature 6) The grouping system according to any one of features 1 to 4, including:

information processors respectively including said waveform collecting sections; and

a grouping device including said waveform comparing section and said group generating section, wherein

at least one of said information processors includes said waveform generating section.
(Feature 7) The grouping system according to any one of features 1 to 4, including: a waveform generator including said waveform generating section;

information processors respectively including said waveform collecting sections; and

a grouping device including said group generating section, wherein

at least one of said information processors includes said waveform comparing section.
(Feature 8) The grouping system according to any one of features 1 to 4, including:

a waveform generator including said waveform generating section; and

information processors respectively including said waveform collecting sections, wherein

at least one of said information processors includes said waveform comparing section and said group generating section.
(Feature 9) A grouping device, including:

a waveform control section that controls generation of a waveform in a waveform generating section that generates the waveform;

a waveform comparing section that compares waveforms indicated by a plurality of pieces of waveform information respectively transmitted from information processors with each other;

a group generating section that groups information processors that transmitted waveform information indicating identical waveforms into one group as a result of comparison by said waveform comparing section.
(Feature 10) An information processor, including:

a waveform generating section that generates a waveform;

a waveform collecting section that collects the waveform generated by said waveform generating section; and

a communication section that transmits waveform information indicating the waveform collected by said waveform collecting section to a grouping device or to other information processors.
(Feature 11) The information processor according to feature 10, including:

a waveform comparing section that compares the waveform collected by said waveform collecting section and waveforms respectively indicated by a plurality of pieces of waveform information transmitted from information processors other than said information processor with each other, wherein

said communication section transmits a result of comparison in said waveform comparing section to said grouping device.
(Feature 12) The information processor according to feature 10, including:

a waveform comparing section that compares the waveform collected by said waveform collecting section and waveforms respectively indicated by a plurality of pieces of waveform information transmitted from information processors other than said information processor with each other; and

a group generating section that groups information processors that transmitted waveform information indicating identical waveforms into one group as a result of comparison by said waveform comparing section.
(Feature 13) The information processor according to feature 10, including a waveform control section that controls generation of the waveform in said waveform generating section.
(Feature 14) A waveform generator, including:

a storage section that stores waveform data respectively corresponding to a plurality of service types;

a control section that reads out waveform information corresponding to the service from said storage section; and

a waveform generating section that generates a waveform indicated by the waveform information read out by said control section.
(Feature 15) A waveform controller, including a waveform control section that controls timing of generating a waveform in a waveform generating section that generates the waveform, or controls a type of the waveform to be generated.
(Feature 16) The waveform controller according to feature 15, including a waveform generating section that generates the waveform controlled by said waveform control section.
(Feature 17) The waveform controller according to feature 15 or 16, including

a waveform comparing section that compares waveforms indicated by a plurality of pieces of waveform information with each other, wherein

said waveform control section reports reference waveform information indicating a reference waveform generated by said waveform generating section to said waveform comparing section, and

said waveform comparing section compares waveforms indicated by a plurality of pieces of waveform information respectively transmitted from information processors with the reference waveform indicated by the reference waveform information.
(Feature 18) A grouping method, including:

waveform generating processing of generating a waveform;

collecting processing of devices respectively collecting the generated waveform;

comparing processing of comparing waveforms respectively collected by the devices with each other; and

grouping processing of grouping the devices that collected identical waveforms into one group as a result of the comparison.
(Feature 19) The grouping method according to feature 18, wherein

said waveform generating processing is performed by a waveform generator, and

said comparing processing and said grouping processing are performed by a grouping device that can communicate with the devices.
(Feature 20) The grouping method according to feature 18, wherein

said waveform generating processing is performed by at least one of the devices, and

said comparing processing and said grouping processing are performed by a grouping device that can communicate with the devices.
(Feature 21) The grouping method according to feature 18, wherein

said waveform generating processing is performed by a waveform generator or at least by one of the devices,

said comparing processing is performed by at least one of the devices, and

said grouping processing is performed by a grouping device that can communicate with the devices.
(Feature 22) The grouping method according to feature 18, wherein

said waveform generating processing is performed by a waveform generator or at least by one of the devices, and

said comparing processing and said grouping processing are performed by at least one of the devices.
(Feature 23) A program for making a computer execute:

a procedure of generating a waveform,

a procedure of collecting the generated waveforms, and

a procedure of transmitting waveform information indicating the collected waveform to a grouping device.
(Feature 24) A program for making a computer execute:

a procedure of storing a plurality of pieces of waveform data respectively corresponding to service types in a storage section provided in the computer,

a procedure of reading out waveform information corresponding to the service from the storage section, and

a procedure of generating a waveform indicated by the read waveform information.
(Feature 25) A program for making a computer execute:

a procedure of controlling timing of generating a waveform or a type of the waveform to be generated.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A grouping system, comprising:
a waveform generating section that generates a waveform;
waveform collecting sections that collect the waveform generated by said waveform generating section;
a waveform comparing section that compares waveforms collected by said waveform collecting sections with each other; and
a group generating section that groups waveform collecting sections that collect identical waveforms into one group as a result of comparison by said waveform comparing section.

2. The grouping system according to claim 1, wherein
said waveform comparing section compares feature values of the waveforms with each other, and
said group generating section groups waveform collecting sections that collect waveforms identical in feature value into one group as a result of comparison by said waveform comparing section.

3. The grouping system according to claim 1, comprising
a waveform control section that controls generation of the waveform in said waveform generating section, wherein
said waveform control section reports waveform information indicating the waveform generated by said waveform generating section to said waveform comparing section, and
said waveform comparing section performs the comparison by using the waveform indicated by the waveform information reported from said waveform control section.

4. The grouping system according to claim 1, wherein
said waveform collecting section outputs to said waveform comparing section timing information indicating timing during which the waveform was collected together with waveform information indicating the collected waveform, and
said waveform comparing section performs the comparison based on the timing indicated by the timing information.

5. The grouping system according to claim 1, comprising:
a waveform generator including said waveform generating section;
information processors respectively including said waveform collecting sections; and
a grouping device including said waveform comparing section and said group generating section.

6. The grouping system according to claim 1, comprising:
information processors respectively including said waveform collecting sections; and
a grouping device including said waveform comparing section and said group generating section, wherein
at least one of said information processors includes said waveform generating section.

7. The grouping system according to claim 1, comprising:
a waveform generator including said waveform generating section;
information processors respectively including said waveform collecting sections; and
a grouping device including said group generating section, wherein
at least one of said information processors includes said waveform comparing section.

8. The grouping system according to claim 1, comprising:
a waveform generator including said waveform generating section; and
information processors respectively including said waveform collecting sections, wherein
at least one of said information processors includes said waveform comparing section and said group generating section.

9. A grouping device, comprising:
a waveform control section that controls generation of a waveform in a waveform generating section that generates the waveform;
a waveform comparing section that compares waveforms indicated by a plurality of pieces of waveform information respectively transmitted from information processors with each other; and
a group generating section that groups information processors that transmitted waveform information indicating identical waveforms into one group as a result of comparison by said waveform comparing section.

10. An information processor, comprising:
a waveform generating section that generates a waveform;
a waveform collecting section that collects the waveform generated by said waveform generating section; and
a communication section that transmits waveform information indicating the waveform collected by said waveform collecting section to a grouping device or to other information processors.

11. The information processor according to claim 10, comprising:
a waveform comparing section that compares the waveform collected by said waveform collecting section and waveforms respectively indicated by a plurality of pieces of waveform information transmitted from information processors other than said information processor with each other, wherein
said communication section transmits a result of comparison in said waveform comparing section to said grouping device.

12. The information processor according to claim 10, comprising:
a waveform comparing section that compares the waveform collected by said waveform collecting section and waveforms respectively indicated by a plurality of pieces of waveform information transmitted from information processors other than said information processor with each other; and
a group generating section that groups information processors that transmitted waveform information indicating identical waveforms into one group as a result of comparison by said waveform comparing section.

13. The information processor according to claim 10, comprising:
a waveform control section that controls generation of the waveform in said waveform generating section.

14. A waveform generator, comprising:
a storage section that stores waveform data respectively corresponding to a plurality of service types;
a control section that reads out waveform information corresponding to the service from said storage section; and
a waveform generating section that generates a waveform indicated by the waveform information read out by said control section.

15. A waveform controller, comprising:
a waveform control section that controls timing of generating a waveform in a waveform generating section that generates the waveform, or controls a type of the waveform to be generated.

16. The waveform controller according to claim 15, comprising:
a waveform generating section that generates the waveform controlled by said waveform control section.

17. The waveform controller according to claim 15, comprising:
a waveform comparing section that compares waveforms indicated by a plurality of pieces of waveform information with each other, wherein
said waveform control section reports reference waveform information indicating a reference waveform generated by said waveform generating section to said waveform comparing section, and
said waveform comparing section compares waveforms indicated by a plurality of pieces of waveform information respectively transmitted from information processors with the reference waveform indicated by the reference waveform information.

18. A grouping method, comprising:
waveform generating processing of generating a waveform;
collecting processing of devices respectively collecting the generated waveform;
comparing processing of comparing waveforms respectively collected by the devices with each other; and
grouping processing of grouping the devices that collected identical waveforms into one group as a result of the comparison.

19. The grouping method according to claim 18, wherein
said waveform generating processing is performed by a waveform generator, and
said comparing processing and said grouping processing are performed by a grouping device that can communicate with the devices.

20. The grouping method according to claim 18, wherein
said waveform generating processing is performed by at least one of the devices, and
said comparing processing and said grouping processing are performed by a grouping device that can communicate with the devices.

21. The grouping method according to claim 18, wherein
said waveform generating processing is performed by a waveform generator or at least by one of the devices,
said comparing processing is performed by at least one of the devices, and
said grouping processing is performed by a grouping device that can communicate with the devices.

22. The grouping method according to claim 18, wherein
said waveform generating processing is performed by a waveform generator or at least by one of the devices, and
said comparing processing and said grouping processing are performed by at least one of the devices.
